(19) United States
(12) Patent Application Publication
(10) Pub. No.: US 2022/0148418 A1
(43) Pub. Date: May 12, 2022

(54) METHOD FOR DETERMINING A NUMBER OF VEHICLE CROSSINGS ON AT LEAST ONE ROAD PORTION OF A ROAD NETWORK

(71) Applicant: IFP Energies nouvelles, Rueil-Malmaison (FR)

(72) Inventors: Maxime JEAN, RUEIL-MALMAISON CEDEX (FR); William BENG, RUEIL-MALMAISON CEDEX (FR); Alexandre CHASSE, RUEIL-MALMAISON CEDEX (FR)

(21) Appl. No.: 17/514,102

(22) Filed: Oct. 29, 2021

(30) Foreign Application Priority Data
Nov. 10, 2020 (FR) 2011523

(51) Int. Cl. G08G 1/01

(52) U.S. Cl. CPC G08G 1/0145; G08G 1/0141; G08G 1/0133; G08G 1/0116

(57) ABSTRACT

The present invention relates to a method for determining a number of vehicle crossings (Nₜₒₜ) on at least one road portion of a road network, wherein measurements using fixed sensors (1) and geolocation measurements (GEO) are performed. For this method, a spatialized scalar field (SCA) is determined. Finally, the number of vehicle crossings (Nₜₒₜ) is determined by way of the determined spatialized scalar field (SCA) (which depends in particular on the measurements using fixed sensors and the geolocation measurements (GEO).

### CROSS-REFERENCE TO RELATED APPLICATION

This application claims priority from French Application No. 20/11.523 filed Nov. 10, 2020 which is hereby incorporated herein by reference in its entirety.

### BACKGROUND OF THE INVENTION

### Field of the Invention

The present invention relates to determining information relating to vehicle traffic for a road network and in particular to a method for determining a number of vehicle crossings on at least one road portion of a road network.

This problem arises for all modes of transport: bicycles, motor vehicles, motorized two-wheeled vehicles, boats, scooters, etc. and also pedestrian movements. However, the growth of motor-free mobility (bicycles, scooters, etc.) is causing a need to precisely determine the usage rate of roads within road networks due to increasing use and the small number of dedicated measurement devices.

### Description of the Prior Art

In order to determine the number of vehicle crossings on a road, it is possible to equip the road with fixed sensors, such as cameras, radars or inductive loops. Such sensors are linked to the road infrastructure. The measurements performed by these sensors have the advantage of being precise. However, they have the major drawback of being stand alone in terms of space: it is not possible to determine the number of vehicle crossings on all of the roads of a road network, and these devices are also expensive. It is necessary to have a large number of fixed sensors to gain a maximum amount of information. For example, in Paris, the number of roads is around 40000 requiring a very large number of fixed sensors if it is desired to ascertain the number of vehicle crossings for all roads.

To determine the number of vehicle crossings on a road, another possibility relates to the use of data measured by geolocation systems, in particular by way of an application integrated into a smartphone. This method makes it possible to obtain measurements of the number of vehicle crossings for a large number of roads of the road network. However, not all users of all vehicles use geolocation systems for all their journeys. Therefore, the measurements obtained in this way do not represent all users of the road network, in quantitative terms but also in qualitative terms. For example, users using a geolocation application on a smartphone do not represent all users of the road network. This type of determination of the number of vehicle crossings on a road of a road network using this method is therefore subject to bias.

There is therefore a need to precisely determine the vehicle usage rate over a set of roads.

In order to precisely obtain information relating to traffic on the road network, consideration has been given to methods for fusing measured data to benefit from the advantages of both types of measured data which are precision and spatially distributed information.

For example, the publication: “STUDY ON DATA FUSION MODEL WITH MULTI-SOURCE HETEROGENEOUS TRAFFIC DATA, Feng-cui QIU, En-jian YAO, Yang YANG, Xin LI, Yi ZHANG, ICTIS 2011, ASCE 2011” relates to the fusion of data from traffic sensors, data from vehicles and number plate data in order to determine an estimate of the speed of movement by way of a method implementing a neural network. Such a method does not make it possible to determine the number of vehicle crossings on a portion of a road network. In addition, this method is a one-dimensional method and is not suited to a two-dimensional space or to a graph representing the road network.

In addition, the publications: “Real-time Traffic Monitoring by fusing Floating Car Data with Stationary Detector Data, M. HOUBRAKEN, K. SCHEERLINCK, 2015 Models and Technologies for Intelligent Transportation Systems (MT-ITS), 3-5 Jun. 2015. Budapest, Hungary” relates to determining traffic in real time by fusing data from vehicles with data from fixed sensors. This method is suited to real time and does not make it possible to determine the number of vehicle crossings. In addition, this method is a one-dimensional method and is not suited to a whole graph representing the road network.

Furthermore, the publication: “Gaussian Process Decentralized Data Fusion and Active Sensing for Spatiotemporal Traffic Modeling and Prediction in Mobility-on-Demand Systems, Jie Chen, Kian Hsiang Low, Yujian Yao, and Patrick Jaillet, IEEE TRANSACTIONS ON AUTOMATION SCIENCE AND ENGINEERING, VOL. 12, NO. 3, JULY 2015” relates to a method for determining speed that implements data fusions between vehicles, and does not take into account data from fixed sensors. This method therefore does not make it possible to take into account precise stand alone measurements. In addition, this method does not relate to determining the number of vehicle crossings on a portion of a road network.

U.S. Pat. No. 5,812,069 relates to a method and a system for predicting traffic flows. This method is based on fusing data from a fleet of vehicles in order to anticipate congestion. This method therefore does not make it possible to determine the number of vehicle crossings on a portion of the road network.

### SUMMARY OF THE INVENTION

The invention precisely, robustly and inexpensively determines the number of vehicle crossings on roads of a road network. To this end, the present invention relates to a method for determining a number of vehicle crossings on at least one road portion of a road network, wherein measurements using fixed sensors and geolocation measurements are performed. For this method, a spatialized scalar field is determined. Finally, the number of vehicle crossings is determined by way of the determined spatialized scalar field (which depends in particular on the measurements using fixed sensors) and the geolocation measurements. The method according to the invention makes it possible to take into account both types of measurement in order to obtain a precise and robust number of vehicle crossings. The spatialized scalar field makes it possible to ensure the robustness of the method.

The invention relates to a method for determining a number of vehicle crossings on at least one road portion of a road network, by way of at least two fixed traffic measurement sensors positioned at measurement points that are arranged within the road network, and by way of measurements during at least one movement of at least one vehicle.

For this method, the following steps are implemented:

a. Measuring a first number of vehicle crossings at the measurement points by fixed sensors;
b. Measuring the geolocation of the at least one vehicle during the at least one movement within the road network, and deducing therefrom a second number of vehicle crossings on each road of the road network taken by the at least one vehicle during the at least one movement; and
c. Determining the number of vehicle crossings on the at least one road portion of the road network by way of the second number of vehicle crossings and by way of a spatial scalar field that depends on the first number of vehicle crossings.

According to one embodiment, the spatial scalar field is determined by determining a spatialized normalization factor, and the number of vehicle crossings on the at least one road portion of the road network is determined by use of the second number of vehicle crossings and by use of the spatialized normalization factor.

Advantageously, the spatialized normalization factor is determined with the following steps:

i. Determining the spatialized normalization factor at the measurement points by use of the measurements by use of the fixed sensors, and by use of the second number of vehicle crossings at the measurement points; and
ii. Determining the spatialized normalization factor on the at least one portion of the road network by extrapolating the spatialized normalization factor determined at the measurement points.

Advantageously, at the measurement points, the normalization factor is defined using the following formula:

$${F}_{n o r m} = \frac{{N}_{cap} + 1}{{( {N}_{geo} + 1 )}^{ρ}}$$

where N_{cap} is the first number of vehicle crossings, N_{geo} is the second number of vehicle crossings, and ρ is a constant.

According to one implementation, the spatial scalar field is a stochastic scalar field.

Advantageously, the spatial scalar field is implemented by way of Gaussian processes.

Preferably, u₁ models ln (Nₜₒₜ+1) is modelled using a Gaussian process u₂ defined on a mathematical graph of the road network, with Nₜₒₜ being the number of vehicle crossings on at least one road portion of the road network, u₂ being defined as u₂=ρu₁+δ where u₁ and δ are two Gaussian processes defined on the graph of the road network and u₁ models ln(N_{geo}+1) where N_{geo} is the second number of vehicle crossings, ρ is a constant, and u₂ models ln(N_{cap}+1) at the measurement points, where N_{cap} is the first number of vehicle crossings measured by the fixed sensors.

According to one aspect, the Gaussian processes of u₁ and δ take into account a measurement of proximity between road portions of the road network in order to construct the kernels of the Gaussian processes.

According to one embodiment option, hyper-parameters of the kernels of the Gaussian processes u₁ and δ are determined by way of a procedure for optimizing the Gaussian process.

According to one embodiment, the geolocation of the at least one vehicle is measured by a geolocation sensor integrated into a smartphone.

According to one implementation, the at least one vehicle is a bicycle.

Advantageously, the fixed sensors are chosen from among cameras, radars, photoelectric cells, piezoelectric cables or inductive loops.

According to one aspect, the method also accounts for at least one journey simulated by a user.

According to one embodiment, the time stamp of the measurements from the fixed sensors and of the geolocation measurements from the at least one vehicle is also measured.

Advantageously, the number of vehicle crossings for a future period is determined for at least one road portion of the road network by use of the measurements from the fixed sensors, the geolocation measurements and the time stamp.

According to one implementation, the determination of the number of vehicle crossings for a future period furthermore takes into account at least one of the weather and a change to the infrastructure of the road network.

According to one aspect, the determined number of vehicle crossings is displayed on a road map, preferably by way of a smartphone or by way of a computer system.

Other features and advantages of the method according to the invention will become apparent on reading the following description of non-limiting exemplary embodiments, with reference to the appended figures described below.

### BRIEF DESCRIPTION OF THE DRAWINGS

FIG. 1 illustrates the steps of the method according to the invention.

FIG. 2 illustrates the steps of the method according to a first embodiment of the invention.

FIG. 3 illustrates the steps of the method according to a second embodiment of the invention.

FIG. 4 illustrates an example of a path for illustrating the method according to the invention.

FIG. 5 illustrates measurements performed for the example of FIG. 4.

FIG. 6 illustrates the number of vehicle crossings determined by the method according to one embodiment of the invention for the example of FIGS. 4 and 5.

FIG. 7 illustrates a map of Paris showing the number of bicycle crossings on the roads, by way of a method according to the prior art.

FIG. 8 illustrates a map of Paris showing the number of bicycle crossings on the roads, by way of the method according to one embodiment of the invention.

### DETAILED DESCRIPTION OF THE INVENTION

The present invention relates to determining a number of vehicle crossings on at least one road portion of a road network which preferably is on the entirety of a road network. The present invention counts the number of vehicles that pass through a road portion. A road network is the name given to a set of roads and paths (in particular for the embodiment involving motor-free mobility) in a predefined geographical area. This predefined geographical area may be a district of a city, a city, a community made up of communes, a region, etc. A road portion is the name given to a road segment, for example between two consecutive intersections, or between two sign posts (two traffic lights for example).

The road network may be represented by a graph, called a road graph. The road graph is a set of edges (also called arcs) and nodes with the nodes possibly representing intersections and the edges representing road portions between the intersections. The road graph may be obtained from an online map service (web service), for example Here Wego™ (Here Apps LLC, the Netherlands), which provides the edges of the graph in the form of pure geometrical objects. The road graph is preferably consistent with the road network (all the physical connections between two roads, and only these, are represented by the nodes of the graph), which is as invariant as possible over time. In addition, the road graph may be simplified, by not accounting for road portions such as closed roads, paths through parks or motorways, depending on the type of vehicle under consideration. For example for the embodiment involving motor-free mobility, motorways might not be taken into account.

The method according to the invention may be implemented for any type of vehicle: bicycles, motor vehicles, two-wheeled motor vehicles, boats, hovercraft, scooters, etc. and also pedestrian movements. However, the method according to the invention is particularly suited to bicycles. Specifically, the problem of the number of vehicle crossings is becoming increasingly significant with the growth of motor-free mobility, and the behavior of cyclists is less known than the behavior of motorists. In general, flows of motor vehicles are already measured accurately in large cities. For example, more than 3000 electromagnetic counting loops are present just in the city of Paris. By contrast, the invention is particularly suitable for inferring flows from a small number of fixed sensors. The method according to the invention is suitable for flows of bicycles in a city, but also for flows of cars in poorly equipped areas. Public transport flows are also generally already known to public transport operators.

The method according to the invention implements measurements obtained from at least two fixed sensors. These fixed sensors are positioned at points of the road network, called measurement points. They allow stand alone measurements of the number of vehicle crossings. The positions of the measurement points are identified within the road network. According to one embodiment of the invention, the fixed sensors may be cameras, radars, inductive loops, sensitive photoelectric cells that detect the interruption of a ray of light, piezoelectric cables that measure the pressure exerted on the roadway or any analogous sensor.

According to the invention, the method also implements measurements during at least one movement of a vehicle within the road network. The road portions of the road network that have been travelled through by at least one vehicle are thus known. Preferably, it is possible to implement measurements of movements of vehicles in order to precisely determine the number of vehicle crossings to gain information about a large number of road portions of the road network. According to one embodiment of the invention, the measurements during the movement may be position measurements, and optionally measurements of the altitude of the vehicle. For example, these measurements may be performed by a geolocation sensor, such as a satellite positioning sensor, such as the GPS (Global Positioning System) system, the Galileo system, etc. The geolocation sensor may preferably be integrated into a smartphone in order to facilitate the measurement and to make the measurement possible for numerous movements and numerous vehicles. In the case of bicycles, the geolocation measurements by way of a smartphone may for example be implemented by way of the Geovelo™ application (Cie des mobilités, France).

According to the invention, the method comprises the following steps:

1) Measurement with fixed sensors
2) Geolocation measurement
3) Determining a number of vehicle crossings

These steps may be implemented by computing apparatus. According to one exemplary embodiment, step 2) may be performed by way of a smartphone, and step 3) may be implemented by way of a computing system comprising a server which possibly maybe in a cloud. The computing symptom may also comprise a computer memory for storing the measurements from the fixed sensors and the geolocation measurements. The smartphone is then in communication with the server. This configuration makes it possible to overcome the constraints of low computing power in smartphones. The steps will be described in detail in the remainder of the description.

In addition, steps 1) and 2) may be performed in this order, in the reverse order, or at the same time. Steps 1) and 2) may preferably be performed at the same time.

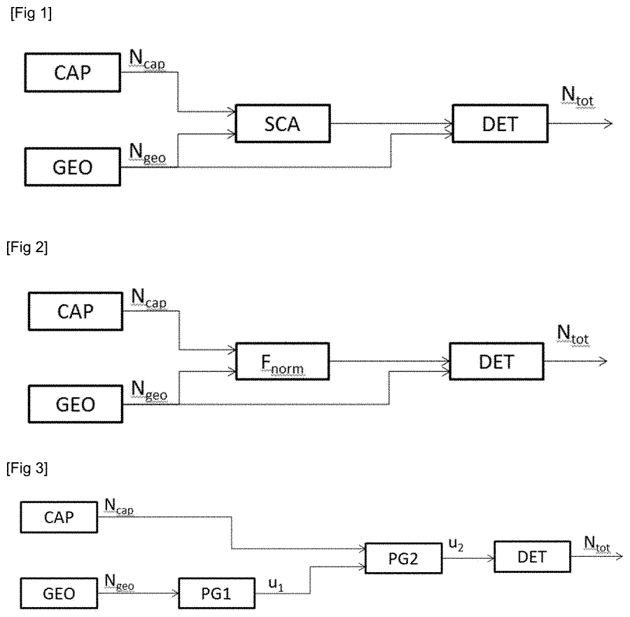

FIG. 1 illustrates, schematically and without limitation, the steps of the method according to the invention. First of all, measurements N_{cap} are performed with fixed sensors CAP, and geolocation measurements N_{geo} are performed by a geolocation sensor GEO. These measurements N_{cap} and N_{geo} are used to determine a spatialized scalar field SCA. The spatialized scalar field SCA and the geolocation measurements N_{geo} are combined in order to determine DET the number of vehicle crossings Nₜₒₜ.

The spatialized scalar field may be determined either deterministically or stochastically.

According to a first implementation of the invention that implements deterministic determination of the spatialized scalar field, the method may comprise the following steps:

1) Measurement with fixed sensors
2) Geolocation measurement
3) Determining a number of vehicle crossings
a) determining a spatialized normalization factor
b) determining a number of vehicle crossings

FIG. 2 illustrates, schematically and without limitation, the steps of the method according to a first embodiment of the invention. First of all, measurements N_{cap} are performed with fixed sensors CAP, and geolocation measurements N_{geo} are performed by a geolocation sensor GEO. These measurements N_{cap} and N_{geo} are used to determine a spatialized normalization factor Fₙₒᵣₘ. The spatialized normalization factor Fₙₒᵣₘ and the geolocation measurements N_{geo} are combined in order to determine DET the number of vehicle crossings Nₜₒₜ.

According to a second implementation of the method that implements stochastic determination of the spatialized scalar field, the method may comprise the following steps:

1) Measurement with fixed sensors
2) Geolocation measurement
3) Determining a number of vehicle crossings
a′) Determining a first Gaussian process that models the flows measured through geolocation
b′) Determining a second Gaussian process that integrates the first process, and a spatialized normalization factor
c′) Determining a number of vehicle crossings

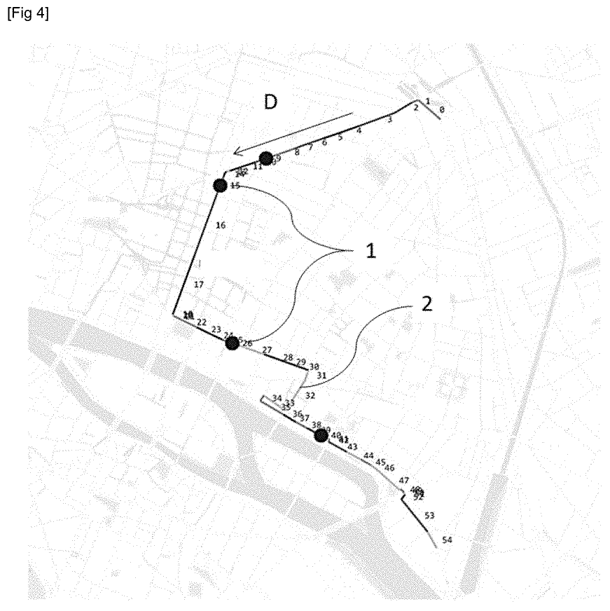

FIG. 3 illustrates, schematically and without limitation, the steps of the method according to a second embodiment of the invention. First of all, measurements N_{cap} are performed with fixed sensors CAP, and geolocation measurements N_{geo} are performed by a geolocation sensor GEO. These last measurements are corrected and extrapolated by a first model PG1 in the form of a Gaussian process u₁. N_{cap} and u₁ are used to determine PG2, a second Gaussian process, u₂ ensuring the spatialized scaling of u₁ so that it is consistent with N_{cap} over all of the fixed measurement points. Determining DET the mean value u₂ and its confidence interval makes it possible to estimate the number of vehicle crossings Nₜₒₜ.

1) Measurement with Fixed Sensors

In this step, a first number of vehicle crossings is measured at the measurement points by way of fixed sensors. This first number of vehicle crossings at the measurement points is stand alone in spatial terms and not in temporal terms and relates only to the measurement points.

According to one aspect of the invention, in this step, it is also possible to time stamp the measurements by fixed sensors in order to ascertain the time of crossing of the vehicle over the measurement points. This measurement may make it possible to determine the number of vehicle crossings for a given period, or may be implemented in a predictive determination of a number of vehicle crossings for a future period.

### 2) Geolocation Measurement

In this step, the geolocation of the at least one vehicle during the at least one movement within the road network is measured, and then a second number of vehicle crossings on each road of the road network taken by the vehicle during the movement is deduced therefrom through counting. In other words, each road portion involved in the at least one movement is identified, and, for each road portion involved in the at least one movement, the number of vehicle crossings is counted. The second number of vehicle crossings is thus spatial and depends on the road portion under consideration.

According to one embodiment, the geolocation measurements may be indicated in the road graph. To this end, it is possible to implement a map-matching method. For example, it is possible to implement the map-matching method from the online service Here WeGo™ (HERE Apps LLC, the Netherlands).

According to one implementation of the invention, it is possible to add simulated movements to these geolocation measurements. Additional information may thus be used in the method in order to determine the number of vehicle crossings more precisely. The simulated movements may correspond to navigation requests made on a geolocation system and for which no geolocation measurement has been performed. Specifically, in some situations, the user may interrogate a geolocation system in order to ascertain their route before they depart, and might not perform any geolocation measurements when they are moving as they will have followed the route determined by the geolocation system.

According to one aspect of the invention, in this step, it is also possible to time stamp the geolocation measurements in order to ascertain the time of crossing of the vehicle over the road portion. This measurement may make it possible to determine the number of vehicle crossings for a given period, or may be implemented in a predictive determination of the number of vehicle crossings for a future period.

### 3) Determining a Number of Vehicle Crossings

In this step, the number of vehicle crossings on the at least one road portion of the road network is determined by determining a spatialized scalar field. The scalar field is a distribution of a scalar in space, and it is spatialized because it is variable in space. In other words, it varies from one road portion to another within the road network and may be determined on road portions for which no sensor measurement or geolocation measurement has been performed. The spatial variability of the spatialized scalar field provides precision and robustness for determining the number of vehicle crossings. The spatialized scalar field is determined in particular based on the first number of vehicle crossings.

The determined number of vehicle crossings is spatial and variable in space and therefore variable from one road portion to another. The number of vehicle crossings determined in this step is different from the first and second numbers of vehicle crossings determined in steps 1) and 2).

The spatialized scalar field may preferably be defined on the graph of the road network.

The spatialized scalar field may be determined either deterministically or stochastically.

For a first implementation for which the spatialized scalar field is determined deterministically which corresponds to the embodiment of FIG. 2, implemented with steps a) and b) described below.

### a) Determining a Spatialized Normalization Factor

In this step, a spatialized normalization factor is determined. The normalization factor is a multiplying coefficient which, if multiplied by the second number of vehicle crossings deduced from the geolocation measurements, makes it possible to determine a coherent and robust number of vehicle crossings. It is determined using in particular the measurements by way of the fixed sensors. The normalization factor is spatialized because it is variable in space. In other words, the normalization factor is not constant, and its value may vary from one road portion to another. The spatial variability of the normalization factor allows precision and robustness in order to determine the number of vehicle crossings.

To determine the normalization factor, the following steps are implemented:
Determining the spatialized normalization factor at the measurement points by use of the first number of vehicle crossings obtained in step 1) and by use of the second number of vehicle crossings obtained in step 2) considered at the measurement points; and
Determining the normalization factor for at least one road portion of the road network using a method of extrapolating the normalization factor determined at the measurement point.

According to one embodiment of the invention, it is possible to define the spatialized normalization factor Fₙₒᵣₘ, defined such that ln(Nₜₒₜ+1)=ρ ln(N_{geo}+1)+ln (Fₙₒᵣm), or similarly (Nₜₒₜ+1)=(N_{g}e, +1)^{ρ}×Fₙₒᵣₘ, where N_{geo} is the second number of vehicle crossings, p is a constant, and Nₜₒₜ is the number of vehicle crossings determined in this step. At the measurement points, Nₜₒₜ corresponds to the first number of vehicle crossings measured by the fixed sensors. The logarithm of the number of vehicle crossings, rather than the number of vehicle crossings directly, is used, since the number of vehicle crossings may vary by orders of magnitude. In addition, to account for the fact that each road portion is not necessarily travelled by at least one vehicle, and since the logarithm function is used, 1 is added to the number of crossings in order to avoid the irregularity of the logarithm function at 0, without otherwise skewing the logic of the algorithm.

According to one exemplary embodiment, the constant ρ may be chosen to be equal to 1. Such a value offers easy interpretation of the algorithm so that the total number of crossings may then be estimated by the product of (N_{geo}+1) and the normalization factor Fₙₒᵣₘ. In the general case, a value other than ρ makes it possible for the model to have greater flexibility, by accounting for the low and high values of (N_{geo}+1) differently. Advantageously, for the measurement points, the normalization factor may be defined using the following formula:

$${F}_{n o r m} = \frac{{N}_{tot} + 1}{{( {N}_{geo} + 1 )}^{ρ}} .$$

The normalization factor Fₙₒᵣₘ may then be obtained over the entirety of the road graph using an interpolation algorithm. For example, a polynomial interpolation in the real plane [symbol] ², representing the geographical area under study, may be chosen. As a variable, other interpolation algorithms may be implemented.

### b) Determining a Number of Vehicle Crossings

In this step, the number of vehicle crossings is determined by a normalization factor and by the second number of vehicle crossings. This step may in particular implement a multiplication of the second number of vehicle crossings and the normalization factor.

According to one embodiment, the number of vehicle crossings Nₜₒₜ, determined in this step 3, may be obtained using the formula Nₜₒₜ=(N_{geo}+1)^{ρ}×Fₙₒᵣₘ−1, where N_{geo} and Fₙₒᵣₘ are defined on each road portion involved in the at least one movement measured through geolocation. The influence of the normalization factor is thus propagated over all of these road portions of the road network.

For a second implementation for which the spatialized scalar field is determined stochastically (which corresponds to the embodiment of FIG. 3), it is possible to implement steps a′), b′) and c′) described below.

For this implementation, it is possible to determine the spatialized scalar field by Gaussian processes, in particular Gaussian processes applied to the graph of the road network.

a′) Determining a First Gaussian Process that Models the Flows Measured Through Geolocation

In this step, a first Gaussian process u₁ that models ln(N_{geo}+1) is determined, where N_{geo} is the second number of vehicle crossings. This model makes possible limiting the noise of the estimate, on each road portion of the network, the number of movements measured through geolocation and passing through the road portion. Specifically, the number of crossings on the various road portions are not independent of one another. It is therefore possible to support the determination of the number of crossings on a road not only by observing the number of crossings on this same road, but also by observing the number of crossings on nearby roads.

The logarithm of the number of vehicle crossings, rather than the number of vehicle crossings directly, is used, since the number of vehicle crossings may vary by orders of magnitude. In addition, to account for the fact that each road portion is not necessarily travelled by at least one vehicle, and since the logarithm function is used, 1 is added to the number of crossings in order to avoid the irregularity of the logarithm function at 0, without otherwise skewing the logic of the algorithm.

The Gaussian processes defined on a graph offer this option, as long as they are provided with a proximity measurement and they are provided with a procedure for constructing their kernel based on this proximity measurement. They also make possible extrapolation of this number of crossings on road portions that might not be passed through by any movement.

For example, the proximity measurement may be the number of journeys obtained by the geolocation measurements (step 2) passing through two roads, plus a constant if these two roads are adjacent in the graph. Thus, the higher the number of cyclists passing through one or the other of the two roads, the closer the two roads will be. For example, the kernel constructed on this measurement may be a modified version of the PageRank™ algorithm (the link analysis algorithm supporting the web page classification system used by the Google™ search engine). The kernel thus constructed makes full use of the information contained in the full geolocation measurements, and not just in numbers of crossings per road, taken independently of one another.

The kernel of the Gaussian process integrates this proximity measurement, modulated by a few (generally fewer than three) parameters, called hyper-parameters. The kernel provides the expected correlation between the implementations of u₁ on two arbitrary road portions of the network. For example, a hyper-parameter of the previous kernel may be the minimum number of movements, measured through geolocation and passing through two arbitrary road portions, required to anticipate a high correlation of the number of crossings on these same two road portions. According to one implementation of the invention, an appropriate optimization procedure may make it possible to adjust the hyper-parameters of the Gaussian process u₁. A nugget effect may also be taken into account. This reflects the uncertainty of the raw measurement and of the degree of flexibility left to the algorithm to not interpolate the measurement points strictly.

For example, this optimization may be a procedure of maximizing the likelihood of the Gaussian process u₁, with knowledge of the measurements of the number of movements measured through geolocation passing through each road portion.

b′) Determining a Second Gaussian Process that Integrates the First Process, and a Spatialized Normalization Factor

In this step, a second Gaussian process u₂ that models ln (Nₜₒₜ+1) is determined, where Nₜₒₜ is the number of vehicle crossings determined in this step 3.

The logarithm of the number of vehicle crossings, rather than the number of vehicle crossings directly, is used, since the number of vehicle crossings may vary by several orders of magnitude. In addition, to take into account the fact that each road portion is not necessarily travelled by at least one vehicle, and since the logarithm function is used, 1 is added to the number of crossings in order to avoid the irregularity of the logarithm function at 0, without otherwise skewing the logic of the algorithm.

It is hypothesized that u₂=ρu₁+δ, where u₁ is the Gaussian process defined in the previous step and δ is a Gaussian process independent of u₁. exp (δ) is then the equivalent, in a stochastic theory context, of the deterministic normalization factor Fₙₒᵣₘ,

The multi-fidelity regression procedure described in the document: “Multi-Fidelity Optimization Via Surrogate Modelling, Forrester et al., 2007.” makes it possible to determine δ and u₂. u₂ is intrinsically coupled to u₁, on the one hand, and to δ, on the other hand. This dual coupling imposes the use of a single unified procedure in order to determine the Gaussian processes u₂ and δ.

In the same way as for the Gaussian process u₁, a proximity measurement and a procedure for constructing the kernel of δ are defined. For example, the kernel of u₂ may be a kernel based on an RBF (radial basis function) function. A radial basis function is an arbitrary real function dependent only on the distance as the crow flies r between each pair of roads. It is possible to adopt in particular the proximity measurement exp (−r²/λ²) where r is the distance as the crow flies between two roads and λ is a hyper-parameter of the model. λ may be interpreted as the characteristic distance between two road portions beyond which poor correlation of the normalization factors is anticipated.

The procedure ensures that the process u₂ corresponds to ln (N_{cap}+1), on each road portion having a counting measurement with N_{cap} being the first number of vehicle crossings. This correspondence is taken in the sense that the expectation of the process on each road portion having a counting measurement is close to ln (N_{cap}+1) and that its variance is low. According to one embodiment, an optimization procedure may make it possible to optimally determine the hyper-parameters of δ. It is in particular ensured that the correlation length occurring in the RBF kernel is large in comparison with the characteristic correlation lengths of the first kernel.

c′) Determining a Number of Vehicle Crossings

In this step, the number of vehicle crossings is determined by way of the second Gaussian process. The number of vehicle crossings is determined by evaluating the expectation [symbol] (u₂) of the second Gaussian process determined in the previous step on all of the road portions of the geographical area under study and its variance [symbol] (u₂). It is then possible to calculate the confidence interval at 95% of the number of crossings: exp( [symbol] (u₂)±1.96 [symbol] )−1.

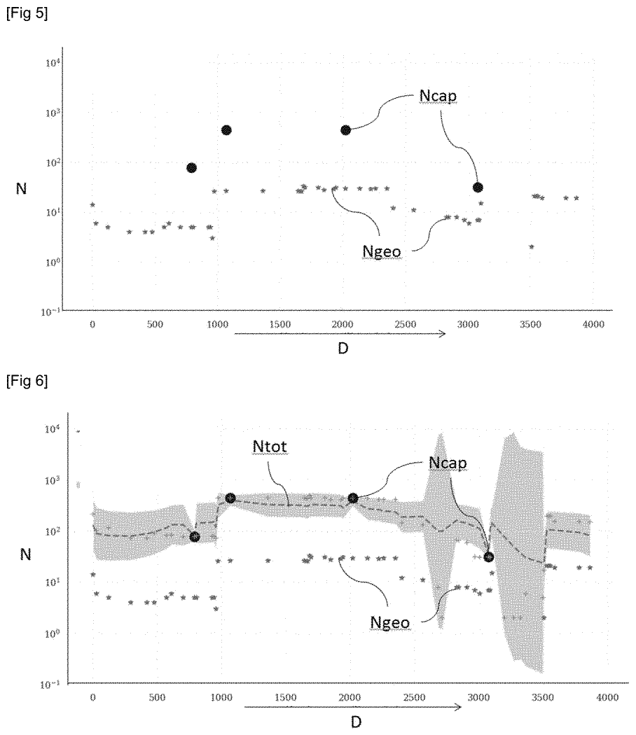

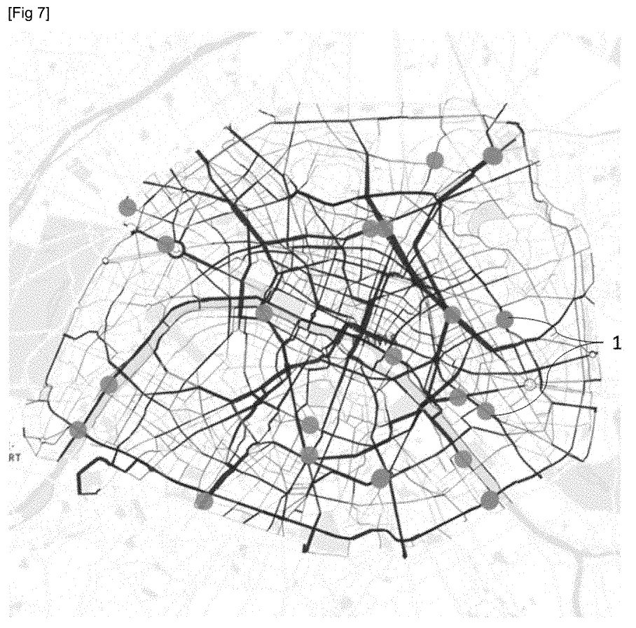

FIGS. 4 to 6 illustrate the second implementation of the invention for a simple example. For this example, consideration is given to a set of road portions in Paris. FIG. 4 illustrates the road portions under consideration on a map. In FIG. 4, the points 1 represent the measurement points measured by the fixed sensors, and the line 2 represents the road portions, numbered from 0 to 54. FIG. 5 shows, on a logarithmic scale, the measurements of the number N of vehicle crossings as a function of the normalized direction D, the direction of which is indicated by an arrow in FIG. 4. The first number of vehicle crossings is denoted N_{cap}, and corresponds to the measurements performed by the fixed sensors. The second number of vehicle crossings is denoted N_{geo}, and corresponds to the measurements performed through geolocation. It is noted that, at the measurement points. The second number of vehicle crossings is lower than the first number of vehicle crossings. The geolocation measurements are therefore not sufficient to precisely determine the number of vehicle crossings. FIG. 6 is similar to FIG. 5. FIG. 6 also contains the plot of the curve Nₜₒₜ, which corresponds to the number of vehicle crossings estimated by the method according to the invention. The grey area around the curve Nₜₒₜ gives a range of uncertainties around the determined number, corresponding to the abovementioned confidence interval. It is noted that the curve Nₜₒₜ does pass through the points N_{cap}. It is additionally noted that the curve Nₜₒₜ has a shape quite similar to the curve N_{geo}, without being a simple translation thereof. The method according to the invention therefore makes it possible to take into account the numbers of vehicle crossings obtained through two different types of measurement, to precisely obtain a precise number of vehicle crossings.

According to one embodiment, the method may implement a posteriori a determination of a number of vehicle crossings. In other words, the number of vehicle crossings for vehicles that have travelled through the road portions of the road network is determined. According to one embodiment option, this determination may be performed for a predefined time interval, for example for a few hours, for one or more days, one or more weeks, one or more months, etc. For this embodiment option, it is possible to implement timestamp measurements.

As an alternative, the method may implement a predictive determination of a number of vehicle crossings for a future period. For this embodiment, the method may implement the measurements from the fixed sensors, the geolocation measurements, and the possible time stamp measurements. Specifically, the possible time stamp measurements make possible taking into account the periodicity of the movements of users of the road network, for example commuting travel times, the day of the week, holiday periods, periods of lockdown, the seasons, etc. Thus, according to one example, the future period may be a few hours, a few days, a few weeks, or even a few months.

In order to improve the prediction for the future period, the method may also take into account the weather. In this case, the method may comprise a step of recording the weather at the same time as the measurements from the fixed sensors, as the geolocation measurements and as the time stamp measurements. Next, a number of vehicle crossings may be determined predictively by way of weather forecasts for the future period. The weather forecasts may be obtained by way of an online service.

In addition, the method according to the invention may comprise a step of displaying the number of vehicle crossings. In this step, the determined number of vehicle crossings is displayed on a road map. This display may take the form of a grade or a color code or a thickness of the depiction of the road. This display may be implemented on board the vehicle: on the dashboard, on an autonomous portable device, such as a (GPS) geolocation device or a mobile telephone (smartphone). It is also possible to display the number of vehicle crossings on a website that the user is able to consult after driving. In addition, the number of vehicle crossings may be shared with public authorities (for example highways manager) and civil engineering companies. Public authorities and civil engineering companies are thus able to determine roads that have a large number of vehicle crossings and adapt the roads to users (for example creating cycle lanes).

FIG. 7 shows a road map of Paris. On this road map, the measurement points of the fixed sensors 1 are represented by grey circles. In addition, the second number of vehicle crossings, for this example of bicycles, is represented by the thickness of the lines and the grey level corresponding to the roads. The thick black lines reflect a large number of bicycle crossings obtained by the geolocation measurements, whereas the thin light grey lines reflect a small number of bicycle crossings obtained by the geolocation measurements. For this figure, the two types of measurement are independent.

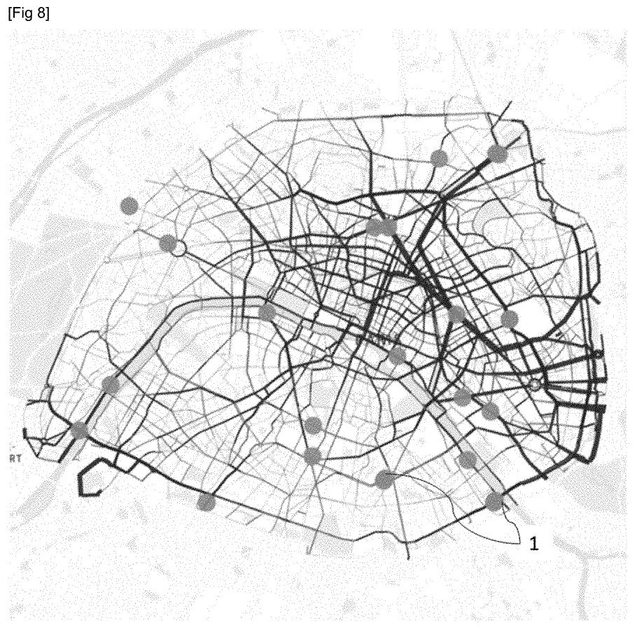

FIG. 8 shows a road map of Paris, similar to FIG. 7. However, in this figure, the thickness and the color of the line of the roads correspond to the number of bicycle crossings obtained by the method according to the invention, taking into account the measurements from the fixed sensors and the geolocation measurements illustrated in FIG. 7. It is stated that the scale of the thickness and the color of the line between FIGS. 7 and 8 are different, but these maps allow a relative comparison of the roads. It is noted that the maps of FIGS. 7 and 8 differ, in particular in the east of Paris, and the number of vehicle crossings determined by the method according to the invention is greater than what is measured through geolocation. This road map may be the one displayed by the method according to the invention, in particular on a website or on a smartphone.

1-17. (canceled)

18. A method for determining a number of vehicle crossings on at least one road portion of a road network, by way of at least two fixed traffic measurement sensors positioned at measurement points arranged within the road network, and by use of measurements during at least one movement of at least one vehicle, comprising steps of:
a. measuring a first number of vehicle crossings at the measurement points by use of the fixed sensors;
b. measuring the geolocation of the at least one vehicle during the at least one movement within the road network, and determining therefrom a second number of vehicle crossings on each road of the road network taken by the at least one vehicle during the at least one movement; and
c. determining the number of vehicle crossings on the at least one road portion of the road network by the second number of vehicle crossings and by use of a spatial scalar field that depends on the first number of vehicle crossings.

19. A method according to claim 18, wherein the spatial scalar field is determined by determining a spatialized normalization factor, and the number of vehicle crossings on the at least one road portion of the road network is determined by use of the second number of vehicle crossings and by use of the spatialized normalization factor.

20. A method according to claim 19, wherein the spatialized normalization factor is determined by steps of:
i. determining the spatialized normalization factor at the measurement points by use of the measurements by use of the fixed sensors, and by use of the second number of vehicle crossings at the measurement points; and
ii. determining the spatialized normalization factor on the at least one portion of the road network by extrapolating the spatialized normalization factor determined at the measurement points.

21. A method according to claim 20, wherein, at the measurement points, the spatialized normalization factor is defined using the formula:
$${F}_{norm} = \frac{{N}_{c a p} + 1}{{( {N}_{g e o} + 1 )}^{ρ}}$$
where N_{cap} is the first number of vehicle crossings, N_{geo} is the second number of vehicle crossings, and ρ is a constant.

22. A method according to claim 18, wherein the spatial scalar field is a stochastic scalar field.

23. A method according to claim 22, wherein the spatial scalar field is implemented by Gaussian processes.

24. A method according to claim 22, wherein ln (Nₜₒₜ+1) is modelled by a Gaussian process u₂ defined on a mathematical graph of the road network, Nₜₒₜ being the number of vehicle crossings on at least one road portion of the road network, u₂ being defined as u₂=ρu₁+δ where u₁ and δ are two Gaussian processes defined on the graph of the road network and u₁ models ln(N_{geo}+1) where N_{geo} is the second number of vehicle crossings, ρ is a constant, and u₂ models ln(N_{cap}+1) at the measurement points, where N_{cap} is said first number of vehicle crossings measured by the fixed sensors.

25. A method according to claim 24, wherein the Gaussian processes of u₁ and δ take into account a measurement of proximity between road portions of the road network in order to construct the kernels of the Gaussian processes.

26. A method according to claim 24, wherein hyper-parameters of kernels of the Gaussian processes u₁ and δ are determined by way of a procedure for optimizing the Gaussian process.

27. A method according to claim 25, wherein hyper-parameters of kernels of the Gaussian processes u₁ and δ are determined by way of a procedure for optimizing the Gaussian process.

28. A method according to claim 18, wherein the geolocation of the at least one vehicle is measured by a geolocation sensor integrated into a smartphone.

29. A method according to claim 18, wherein the at least one vehicle is a bicycle.

30. A method according to claim 18, wherein the fixed sensors are chosen from among cameras, radars, photoelectric cells, piezoelectric cables or inductive loops.

31. A method according to claim 18, further comprising taking into account at least one journey simulated by a user.

32. A method according to claim 18, wherein the time stamp of the measurements from the fixed sensors and of the geolocation measurements from the at least one vehicle is also measured.

33. A method according to claim 32, wherein a number of vehicle crossings (Nₜₒₜ) for a future period is determined for at least one road portion of the road network by way of the measurements from the fixed sensors, the geolocation measurements and the time stamp.

34. A method according to claim 33, wherein the determination of the number of vehicle crossings for a future period also accounts for at least one of the weather and a change to infrastructure of the road network.

35. A method according to claim 18, wherein the determined number of vehicle crossings is displayed on a road map, by either a smartphone or a computer system.

36. A method according to claim 19, further comprising taking into account at least one journey simulated by a user.

37. A method according to claim 20, further comprising taking into account at least one journey simulated by a user.
